(19) United States
(12) Patent Application Publication
(10) Pub. No.: US 2008/0060575 A1
(43) Pub. Date: Mar. 13, 2008

(54) COATING INSTALLATION AND ASSOCIATED OPERATING PROCEDURE

(75) Inventor: Alexander Meissner, Stuttgart (DE)

Correspondence Address: YOUNG & BASILE, P.C., 3001 WEST BIG BEAVER ROAD, SUITE 624, TROY, MI, 48084, US

(73) Assignee: DURR SYSTEMS, INC., Auburn Hills, MI (US)

(21) Appl. No.: 11/853,896

(22) Filed: Sep. 12, 2007

Related U.S. Application Data
(60) Provisional application No. 60/843,884, filed on Sep. 12, 2006.

(51) Int. Cl. B05D 1/00; B05C 5/00

(52) U.S. Cl. 118/313; 901/14

(57) ABSTRACT

Coating installation, specifically for painting motor vehicle body parts, having at least two application robots for applying a coating medium to an application target, at least two handling robots for handling the application target and two linear guides along which the handling robots and the application robots can be moved. Each of the two linear guides carries at least one of the application robots and at least one of the handling robots.

### RELATED APPLICATIONS

This application claims the benefit under 35 U.S.C. §119(e) of U.S. application Ser. No. 60/843,884 filed on Sep. 12, 2006, which is incorporated by reference herein in its entirety.

### FIELD OF THE INVENTION

The invention relates to a coating installation and an associated operating procedure, in particular for painting motor vehicle body parts in accordance with the preamble of the dependent claims.

### BACKGROUND

A painting installation is known from WO 01/68267 A1 for painting motor vehicle body parts in which the motor vehicle body parts on a paint line are transported in succession through several paint zones located one after the other. Two linear guides are located on both sides of the paint line, disposed one above the other where the upper guide has several handling robots (e.g. hood openers or door openers) moveable in the longitudinal direction of the linear guide while the lower linear guide carries several application robots moveable in the longitudinal direction of the linear guide.

The advantage of this known painting installation is the fact that the application robots on the one hand and the handling robots on the other hand can be positioned in the longitudinal direction without mutual interference since the two different types of robot are assigned to one of the two linear guides.

The disadvantage of this know painting installation with a separate guide for the application robots on the one hand and the handling robots on the other hand is, however, the fact that a malfunction in the ability of an application or a handling robot to move and a resulting shutdown of the particular handling or application robot results in a substantial restriction of the application or handling status of the affected paint cell since the failed application or handling robot blocks adjacent robots of the same type (application robots or handling robots) so that they cannot compensate for this malfunction.

### SUMMARY

It would be desirable in the invention to increase the immunity to malfunctions of the paint installation described initially.

An embodiment according to the invention can increase the immunity to malfunctions of the paint installation.

The invention according to one embodiment embraces the general technical teaching of not assigning the application robots on the one hand and the handling robots (e.g. hood openers or door openers) on the other hand to the same linear guide in order to prevent them from blocking the other still functional robots of the same type in the event of a breakdown of a handling or application robot and thus preventing the functional robots of adjacent paint cells from taking over the function of the failed robot. Instead, the invention provides for each of the linear guides to carry application robots as well as handling robots so that in the event of a failure of an application or handling robot on one linear guide, the possibility exists that an application or handling robot from the other linear guide assumes the function of the failed robot so that the coating installation in accordance with one embodiment of the invention is failure-tolerant.

In a coating installation with two linear guides each of the two linear guides can carry at least one of the application robots and at least one of the handling robots.

The coating installation in accordance with one embodiment of the invention has two linear guides which can be located on one side or on both sides of the paint line, where the linear guides can be located one above the other and can run parallel to each other.

The term “application robot” used within the scope of the invention is to be understood generally and is not restricted to multi-axis robots in the narrower sense. Rather, the term “application robot” within the scope of the invention includes devices which allow automated application of a coating medium without having several moveable axes. However, the application robot within the scope of the invention can be a multi-axis robot with a highly moveabe robot wrist axis which carries a rotary atomizer as the application equipment.

In the case of the handling robot, it can, for example, be a hood opener known per se or a similarly known door opener, but the invention is not restricted to such embodiments for the handling robot.

It should further be mentioned that the invention is not restricted to paint installations but includes coating installations in general in which a coating medium (e.g. primer, filler, basecoat, clearcoat, shipping wax) is applied.

As a result of the arrangement of the application robots on the one hand and the handling robots on the other distributed over the different linear guides, a malfunction-related breakdown of an application robot does not result in the blocking of all robots of the same type since the application or handling robots carried on the other linear guide are not affected by the breakdown. As a result, the advantageous possibility exists that the failure of a robot on one linear guide is balanced by a functional robot of the same type on the other linear guide.

The application or handling robots of the one linear guide can pass the application or handling robots of the other linear guide in the longitudinal direction. This offers the advantage that a malfunction-related breakdown of a robot on the one linear guide does not hamper the movement of the robots on the other linear guide.

In one embodiment of the invention, handling robots and application robots are located alternately one after the other on the individual linear guides in the longitudinal direction. This offers the advantage that in the event of a failure of one robot the average distance to the next robot of the same type on the other linear guide is minimal.

The coating installation in accordance with one embodiment of the invention has several coating zones located one after the other through which the linear guides run, where in the individual coating zones at least one handling robot and at least one application robot is located. In the case of an operating failure of a handling or application robot in one coating zone, a same type robot from an adjacent coating zone can be summoned to assist in balancing out the operating failure.

In the individual coating zones, the handling robot can be mounted on the one linear guide, while the application robot is carried on the other linear guide, where the assignment of handling robot and application robot to the linear guides can switch between the individual coating cells.

Alternatively, the possibility exists that the handling robot and the application robot are both mounted on the same linear guide in the individual coating zones, where the particular linear guide changes from coating zone to coating zone. For example, the possibility exists that the handling robot and the application robot are mounted to the upper linear guide in one coating zone while the handling robot and the application robot are mounted to the lower linear guide in the adjacent coating zone.

In a variant of the invention, the coating installation has a transport line along which the application target (e.g. a motor vehicle body) is transported through the coating installation where the linear guides for the handling or application robot are located above the transportation line and/or above the application target. The handling or application robot thus does not rest on the foundation of the coating installation but is raised upward. This arrangement has proved to be better in practice for airflow whereby transfer efficiency is increased and overspray is reduced.

The raised arrangement of the linear guides can be implemented, for example, by means of supporting legs by which the linear guides are raised upward relative to the foundation. Alternatively, it is also possible to mount the application or handling robot to the side wall of the painting cell so that no supporting legs are required.

To optimize airflow characteristics, the space in the longitudinal direction between the supporting legs can be permeable to airflow in the lateral direction, which contributes to the aforementioned improvement in transfer efficiency and reduction of overspray.

In one embodiment of the invention, the coating installation has a least one box-shaped, elongated sectional girder with several side walls, wherein the linear guides are mounted to the side walls of the girder. For example, the girder can have a rectangular profile, where the side wall of the girder facing the transport line forms a linear guide while the lower wall of the girder forms the other linear guide. Through this arrangement of several linear guides on one girder, construction space, weight and material expenditure for the linear guides are reduced.

Furthermore, the possibility exists that at least two linear guides are located on both sides of the transport line for the application target (e.g. a motor vehicle body) where each of the linear guides carries at least one of the application robots and at least one of the handling robots. Each side of the painting cell thus is immune to a breakdown of one of the application or handling robots.

The possibility further exists that the linear guides located on the opposite sides of the transport line are interconnected by at least one cross brace, where the cross brace can run above the transportation line and/or above the application target. The application target can thus be taken through along the transportation line under the cross brace.

It is furthermore advantageous if the individual linear guides are preassembled at least in pairs thereby reducing assembly time and thus also the down times of the affected coating installation.

In addition, the invention includes an operating method for the coating installation in accordance with one embodiment the invention in which at least one of the application robots and at least one of the handling robots is carried on the individual linear guides of the coating installation to make it possible to tolerate a failure, as was described previously.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like part throughout the several views, and wherein:

FIG. 1 shows a perspective view of an inventive painting installation on one side of a paint line.

FIG. 2 shows a front view of the painting installation from FIG. 1.

FIG. 3 shows a plan view of the painting installation from FIG. 1.

FIGS. 4a-4c shows schematic representations of an inventive coating installation, in error-free operation or when a robot breaks down,

FIG. 5a-FIG. 5c show further schematic representations of an inventive coating installation, in failure-free operation or when a robot breaks down,

FIGS. 6a-6c show various views of an inventive painting cell of a coating installation.

### DETAILED DESCRIPTION

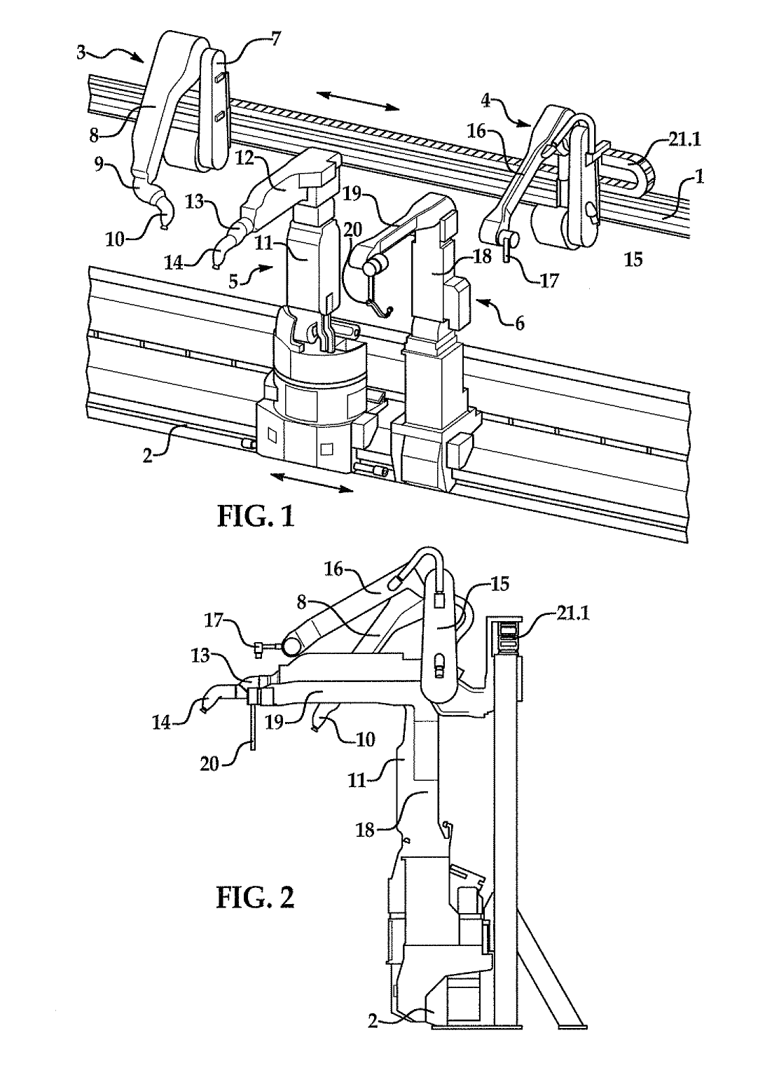

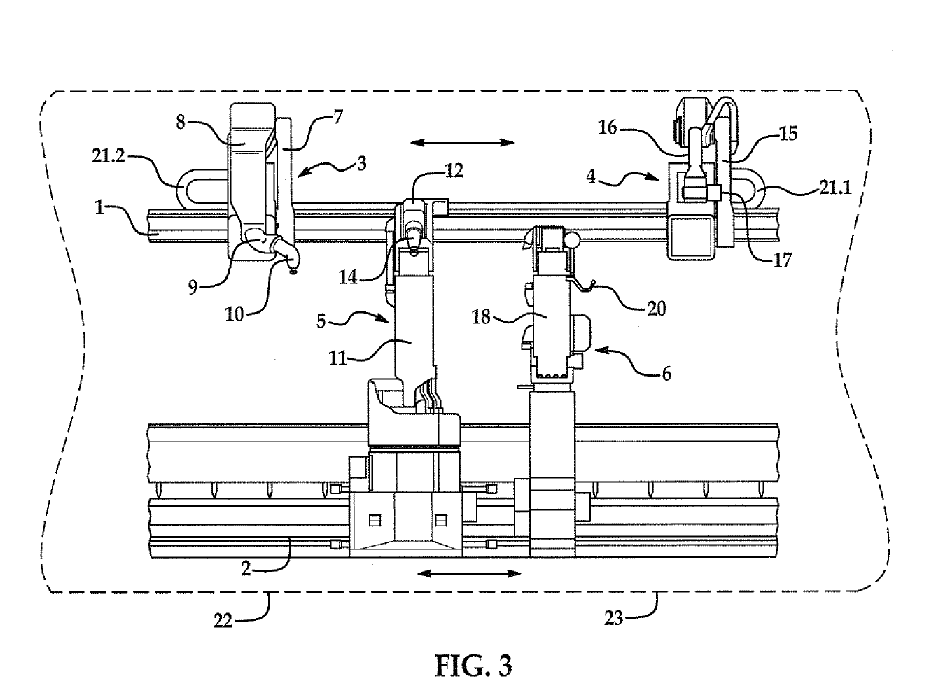

The perspective views in FIGS. 1 to 3 show an inventive painting installation on one side of a paint line, where for simplicity the paint line itself and the opposite side of the painting installation are not shown.

The painting installation has two linear guides 1, 2 located one above the other and running parallel, where the upper linear guide 1 carries a painting robot 3 and a handling robot 4 moveable in the direction of the arrow, while the lower linear guide 2 carries a painting robot 5 and a handling robot 6 moveable in the direction of the arrow.

The painting robot 3 is largely conventional in construction and has several robot arms 7, 8 and a robot wrist axis 9 which carries a rotary atomizer 10.

The painting robot 5 is also largely conventional in construction and has several robot arms 11, 12 and a robot wrist axis 13 which carries a rotary atomizer 14.

In the case of the handling robot 4, it is a largely conventionally constructed door opener which opens the doors on unpainted motor vehicle bodies for the painting process. The handling robot 4 has several robot arms 15, 16 and a pivotable gripper 17. In addition, the handling robot 4 also has a wrist axis of single-axis design.

In the case of the handling robot 6 on the other hand, it is a largely conventionally constructed hood opener which opens a hood or a trunk lid on an unpainted motor vehicle body during the painting process. For this, the handling robot 6 has several robot arms 18, 19 and a suitably adapted gripper 20. In addition, the handling robot 6 also has a wrist axis of single-axis design.

The painting robot 3 and the handling robot 4 on the upper linear guide 1 are supplied by two separate supply lines 21.1, 21.2 where in FIG. 1 only supply line 21.1 is shown. The painting robot 3 and the handling robot 4 are moveable in the direction of the arrow.

The painting robot 5 and the handling robot 6 on the lower linear guide 2 are moveable in the direction of the arrow which makes it possible in the event of a painting robot 5 or handling robot 34 failure for the other painting robot 3 or 5 respectively to step in for the failed painting robot 3 or 5 whereby the inventive painting installation becomes more tolerant of breakdowns.

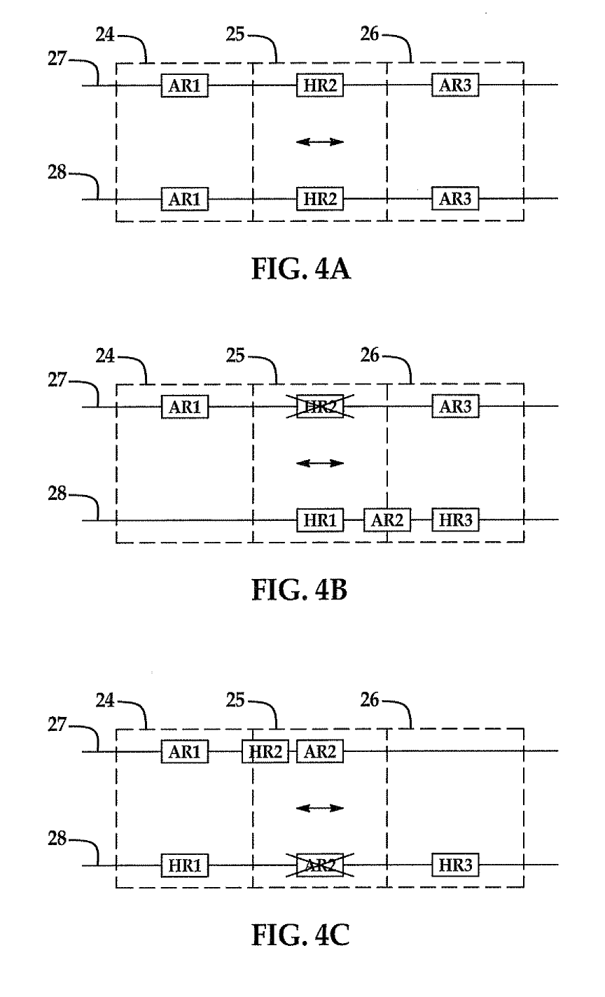

From FIG. 3 it is further evident that that the inventive painting installation has several painting zones arranged one after the other in the longitudinal direction of the two linear guides 1, 2, where for simplicity only two painting zones 22, 23 are shown. In the event of a failure of the painting robot 3 in painting zone 22, painting robot 5 from painting zone 23 can be summoned to help. The painting robot 5 is then moved in the direction of the arrow out of painting zone 23 into painting zone 22 to the place of the defective painting robot 3 where it temporarily assumes its function. In this way there is compensation for failures across painting zones whereby a failure-tolerant system is created.

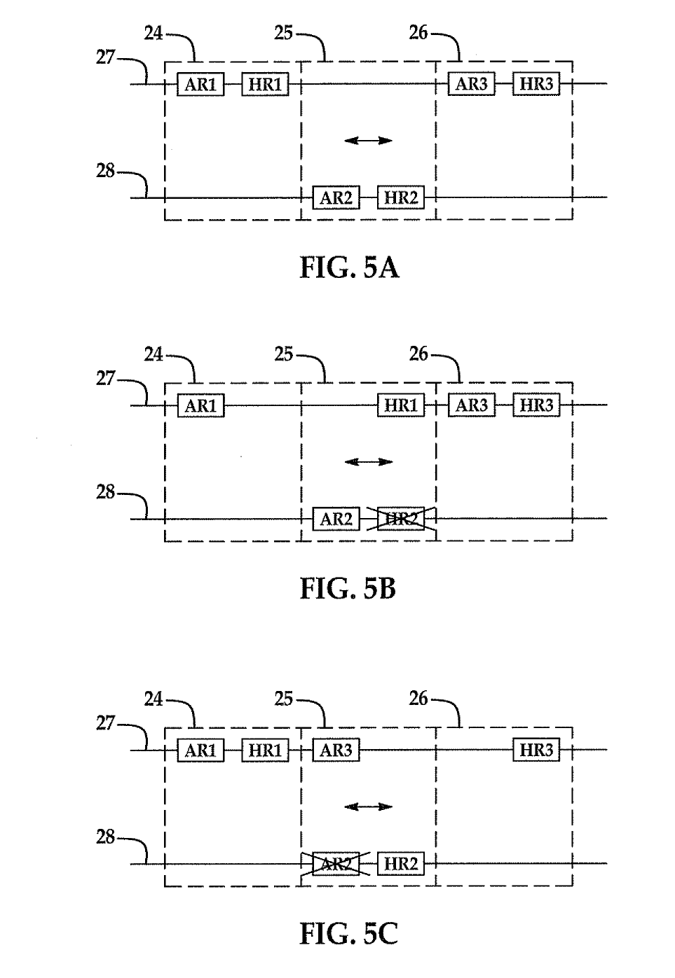

FIGS. 4a-4c show schematic renderings of an inventive coating installation having several coating zones 24, 25, 26 through which the two linear guides pass, located one above the other and running parallel.

The upper linear guide 27 alternately carries an application robot AR1, a handling robot HR2 and an application robot AR3 in the longitudinal direction, while the lower linear guide 28 alternately carries a handling robot HR1, an application robot AR2 and a handling robot HR3 moveable in the direction of the arrow.

In the failure-free operation shown in FIG. 4a an application robot AR1, AR2 or AR3 and a handling robot HR1, HR2 or HR3 is located in each of the coating zones 24-26 which work together in pairs.

FIG. 4b, on the other hand, shows a failure condition in which handling robot HR2 has broken down in coating zone 25 and can no longer be moved in the direction of the arrow. In the case of a failure like this, handling robot HR1 is moved temporarily out of coating zone 24 into coating zone 25 with the defective handling robot HR2 and temporarily assumes its function there.

FIG. 4c, on the other hand, shows an error condition in which application robot AR2 from coating zone 25 has broken down due to a malfunction and can no longer be moved in the direction of the arrow. In the case of this failure, application robot AR3 from coating zone 26 is moved along with the inoperative application robot AR2 into coating zone 25 and temporarily assumes its function there.

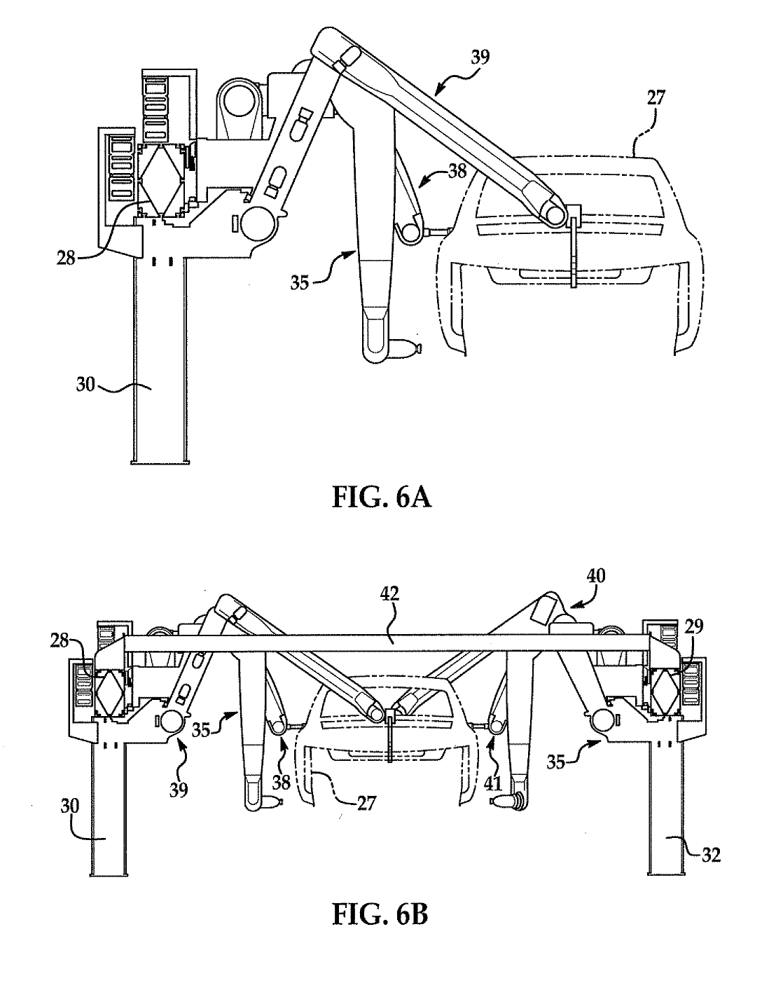

The embodiment of an inventive coating installation shown in FIGS. 5a to 5c is largely identical to the embodiment shown in FIGS. 4a to 4c and described previously so that reference is made to the previous description to avoid repetition, with the same reference numerals being used for corresponding parts or subassemblies.

One special feature of this embodiment is that in each of the coating zones 24-26 a pair consisting of an application robot AR1, AR2 or AR3 and a handling robot HR1, HR2 or HR3 is located on the same linear guide 27 or 28. The two types of robot (handling robot or application robot) are located on the same linear guide 27 or 28 within the individual coating zones 24-26, where the linear guide being used 27 or 28 alternates between the individual coating zones 24-26.

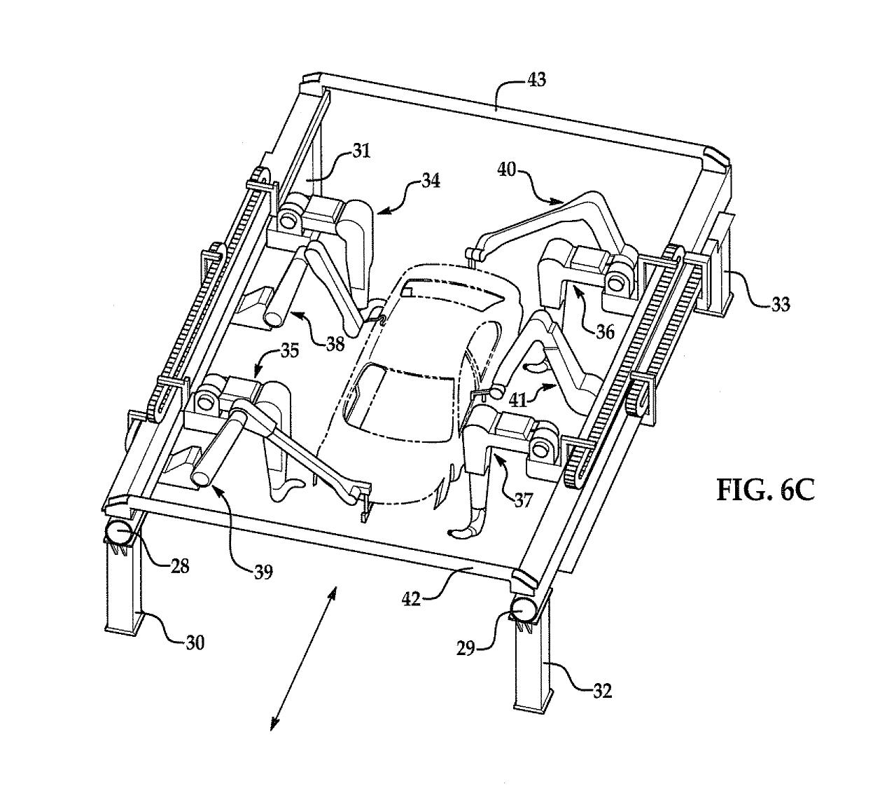

FIGS. 6a to 6c show different views of an inventive painting cell of a coating installation for coating motor vehicle bodies, with only one motor vehicle body 27 being shown in the drawings. The motor vehicle body 27 is transported in the direction of the arrow in FIG. 6c along a transport line through the coating installation and coated in the process.

A box-shaped, elongated sectional girder 28, 29 having a rectangular profile is located on both sides of the transport line, with the side walls of the two girders 28, 29 forming linear guides, as will be described in more detail.

The girders 28, 29 are raised upwards by supporting legs 30-33 relative to the foundation so that the sectional girders 28, 29 and consequently the linear guides as well run above the transport line and partially even above the motor vehicle body 27, which is positive for airflow, as will also be described in more detail.

The sides of the sectional girders 28, 29 facing the transport line each form a linear guide for application robots 34-37, while the undersides of the girders 28, 29 each form a linear guide for handling robots 38-41.

The two handling robots 38, 39 are thus carried by the one linear guide on girder 28, while the two handling robots 34, 35 are carried by the other linear guide on girder 28.

On the opposite side of the transport line, the two handling robots 40, 41 are correspondingly carried by the one linear guide on girder 29, whereas the two application robots 36, 37 are carried by the other linear guide on girder 29.

Thus, each of the linear guides carries either only application robots or only handling robots inside the painting cell shown. The redundancy described at the beginning is achieved by the distribution of the application robots and the handling robots switching to the different linear guides from painting cell to painting cell.

The raised position of the application robots 34-37 is more favorable for airflow since the space between the legs 30, 31 or 32, 33 in the longitudinal direction of the transport line is open to airflow in the lateral direction, which in practice leads to improved transfer efficiency and reduces overspray.

In the completely assembled state, the girders 28 and 29 are connected at both ends of the painting cell by a cross brace 42, 43, where the motor vehicle body 27 can be transported below the cross braces 42, 43 so that they do not represent an obstruction.

It should be mentioned further that girder 28 can be pre-assembled with the supporting legs 30, 31, the application robots 34, 35 and the handling robots 38, 39 as a module. In the same way, of course, girder 29 can be pre-assembled as a module with the supporting legs 32, 33, the application robots 36, 37 and the handling robots 40, 41. This modular pre-assembly allows rapid final assembly at the coating installation concerned, which reduces the down times of the coating installation.

The invention is not restricted to the previously described embodiments. A plurality of variants and modifications is possible which make similar use of the inventive idea and therefore fall within the scope of its patent protection.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A coating installation, specifically for painting motor vehicle body parts, having at least two application robots for applying a coating medium to an application target, at least two handling robots for handling the application target and two linear guides along which the handling robots and the application robots can be moved, characterized in that:
each of the two linear guides carries at least one of the application robots and at least one of the handling robots.

2. The coating installation of claim 1, wherein the application or handling robots on the one linear guide can pass the application or handling robots on the other linear guide in the longitudinal direction.

3. The coating installation of claim 1, wherein the two linear guides are located one above the other.

4. The coating installation of claim 1, wherein the two linear guides run essentially parallel to each other.

5. The coating installation of claim 1, wherein the handling robots are door openers or hood openers.

6. The coating installation of claim 1, wherein handling robots and application robots are located alternately on the two linear guides in the longitudinal direction.

7. The coating installation of claim 1, wherein the linear guides pass through several coating zones where at least one handling robot and at least one application robot is located in the individual coating zones.

8. The coating installation of claim 7, wherein the handling robot and the application robot in the individual coating zones are located on different linear guides.

9. The coating installation of claim 1 characterized by a transport line for transporting the application target through the coating installation, where the linear guides are located above the transport line and/or above the application target.

10. The coating installation of claim 1, wherein the linear guides are raised upwards by supporting legs relative to a foundation.

11. The coating installation of claim 10, wherein the space between the supporting legs in the longitudinal direction is open to airflow in the lateral direction.

12. The coating installation of claim 1, characterized by a box-shaped, elongated sectional girder with several side walls, where the linear guides are located on the side walls of the girder.

13. The coating installation of claim 1, characterized by a transport line for transporting the application target through the coating installation where at least two linear guides are located on both sides of the transport line, while each of the linear guides carries at least one of the application robots and at least one of the handling robots.

14. The coating installation of claim 13, wherein the linear guides on the two sides of the transport line are connected by at least one cross brace.

15. The coating installation of claim 14, wherein the cross brace is located above the transport line and/or above the application target.

16. The coating installation of claim 1, wherein the linear guides are pre-assembled at least in pairs.

17. An operating method for a coating installation having at least two linear guides on which several application robots and several handling robots can be moved in the longitudinal direction, characterized in that:
at least one of the application robots and at least one of the handling robots is carried on the two linear guides.

18. The operating method of claim 17, wherein at least one of the application or handling robots on the one linear guide is moved past at least one of the application or handling robots on the other linear guide in the longitudinal direction.

19. The operating method of claim 18, characterized by several coating zones located one after the other in the longitudinal direction of the linear guides in which at least one handling robot and at least one application robot is located, where a failure in an application robot in a coating zone is compensated for by an application robot being moved from another of the several coating zones into the coating zone with the defective application robot and/or a defect in a handling robot in a coating zone is compensated for by a handling robot being moved from another of the several coating zones into the coating zone with the defective handling robot.
